(19) United States
(12) Patent Application Publication
(10) Pub. No.: US 2019/0322425 A1
(43) Pub. Date: Oct. 24, 2019

(54) In-bottle apparatus for adding flavorings to pre-packaged drinks

(71) Applicant: Michael Thomas Beery, Minneapolis, MN (US)

(72) Inventor: Michael Thomas Beery, Minneapolis, MN (US)

(21) Appl. No.: 15/935,510

(22) Filed: Mar. 26, 2018

(51) Int. Cl. B65D 51/28; B65D 41/04; B65D 81/32; A23L 2/56; A47J 43/27

(52) U.S. Cl. CPC B65D 51/2878; B65D 41/04; A23V 2002/00; A23L 2/56; A47J 43/27; B65D 81/3216

(57) ABSTRACT

The present invention comprises a novel in-bottle apparatus for adding flavorings to pre-packaged drinks. The apparatus, which is fully contained within a sealed drink bottle just below the bottle's lip, has a selector that allows the user to choose from a plurality of flavorings that can be released from a dispenser with the push of a button. The push button heads that make up the flavoring selector correspond to flavorings contained within the dispenser. Pushing one or more of the button heads dispenses flavoring into the primary drink contained within the drink bottle. The apparatus has a passageway on one side that allows the drink to be poured out of the bottle. The apparatus remains locked within the drink bottle's neck just below the bottle's lip before use, during use, while the drink is being consumed, and after the drink bottle is disposed of.

### FIELD OF THE INVENTION

The present invention relates to pre-packaged drinks sold from vending machines, retail outlets and online merchants. Drinks such as coffee and tea are consumed with a variety of added flavorings making vending them difficult due to all the possible flavor combinations. More particularly, the invention relates to an apparatus for adding flavorings to pre-packaged drinks. The apparatus, which is fully contained within a drink bottle, has a selector that allows the user to choose from a plurality of flavorings that can be dispensed into the primary drink with the push of a button. The drink's flavor is customized by the user with flavorings already contained within the drink bottle itself, without mess or items to dispose of.

### CROSS-REFERENCE TO RELATED APPLICATIONS

The present application claims priority to the earlier filed provisional patent application having the Ser. No. 62/505,937, and hereby incorporates subject matter of the provisional application in its entirety filed on the date of May 14, 2017.

### BACKGROUND OF THE INVENTION

Coffee, tea, and mineral water are a rapidly growing segment of the pre-packaged drink industry. Unlike sodas, these drinks are typically served with added flavorings. Coffee is most often augmented by flavorings such as sugar, cream, vanilla, caramel and mocha. This has made pre-packaging these types of drinks difficult because bottling all the popular flavoring combinations requires a wide array of offerings.

Vended soda sales are in decline because consumers are seeking out healthier alternatives. Providing the wide variety of flavor choices consumers expect from healthy drinks such as coffee, tea, and mineral water has created a challenge. There exists a need in the field for a convenient, mess-free method for consumers to alter the flavor of pre-packaged bottled drinks to satisfy their particular flavoring tastes.

Currently there isn't a method of providing multiple flavoring options within a single pre-packaged drink bottle using a selection and dispensing system. Providing consumers a simple and convenient way to add their choice of sugar, cream, vanilla, mocha, or other flavorings to their pre-packaged bottled coffee drink would make this class of beverages more attractive to consumers.

Likewise, with mineral water products, providing consumers an in-bottle flavoring selection and dispensing apparatus with a plurality of flavors to choose from would allow vending machine operators and certain retailers to offer a wider flavoring selection for their customers. Rather than the current practice of offering plain mineral water.

In addition, an in-bottle flavoring selection and dispensing apparatus would allow consumers the ability to provide drinks for others without knowing what their particular flavoring preference might be. Providing a pre-packaged drink bottle utilizing this apparatus would allow the recipient to customize the flavoring themselves. Additionally, bottled drinks pre-packaged with this apparatus would reduce the need to stock a variety of flavored drinks only to have a particular flavor option run out completely.

Therefore, a need exists in the field for a convenient, mess-free flavoring selection and dispensing apparatus pre-installed within sealed pre-packaged bottled drinks that would provide a wider selection of flavors within the limited shelf space available in most vending machines and retail outlets. A further need exists for an apparatus able to accommodate primary drink flavors such as coffee, tea, and mineral water that are most often served with added flavorings that augment the primary drink's flavor. Finally, there is a need in the field for flavor-customizing options when providing drinks for guests when you are unsure of what their flavoring preferences might be, whereby reducing the need to guess which flavors are desired ahead of time or the need to stock multiple drink flavor options.

### BRIEF SUMMARY OF THE INVENTION

The present invention comprises a novel flavoring selection and dispensing apparatus designed to alter the primary drink flavor contained within sealed drink bottles. The apparatus is fully contained within the sealed pre-packaged drink bottle. The apparatus allows for a selection of flavorings to be dispensed into the primary drink through the use of a push button selection and dispensing system suspended within a drink bottle's neck and locked just below the drink bottle's lip. The push button heads of the selector correspond to flavorings contained within the dispensing apparatus, Pushing one or more of the buttons dispenses flavoring into the primary drink without mess or items to dispose of. The custom-flavored drink can be consumed through a passageway on one side of the apparatus. The apparatus remains within the drink bottle before use, during use, while the drink is being consumed, and after the drink bottle itself is properly disposed of.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of the flavorings dispenser, the neck lock, and a view of the dispenser being filled with a flavoring according to various embodiments of the present invention.

FIG. 2 illustrates a perspective view of the push button arms, the dispenser, the neck lock, and the flavoring container seal according to various embodiments described herein.

FIG. 3 depicts a perspective view of a selector and dispenser apparatus full of flavorings rotated into the upright position locked properly within a drink bottle's neck according to various embodiments described herein.

FIG. 4 depicts a side view of a selector and dispenser apparatus full of flavorings locked within a drink bottle's neck just below the bottle's lip with the drink bottle's cap screwed on and sealed according to various embodiments described herein.

FIG. 5 depicts a perspective view of the apparatus in use, namely a push button head depressed by a finger tip, whereby opening a flavoring container seal and releasing a flavoring from the dispenser into the primary drink according to various embodiments described herein.

FIG. 6 depicts a perspective view of a drink being poured through the passageway on one side of a selector and dispenser apparatus locked within a drink bottle's neck just below a drink bottle's lip according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new in-bottle apparatus for adding flavorings to pre-packaged bottled drinks, and methods for customizing the flavor of pre-packaged bottled drinks are discussed herein. In the following description numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

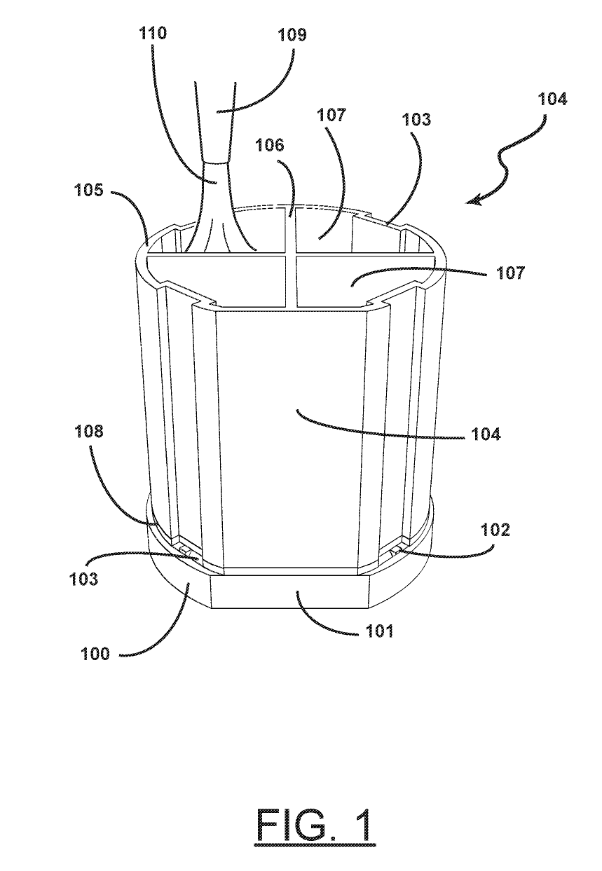

The present invention will now be described by referencing the appended figures representing preferred embodiments. FIG. 1 depicts a neck lock 100 that suspends the apparatus inside the drink bottle in a rigid manner and connects it to the bottle's neck tightly. One side of the neck lock 100 is flat creating a drink passage way 101. The neck lock 100 also has a push button arm track 103 which is designed to allow a push button head to move vertically where it is eventually secured by a push button head lock 102. FIG. 1 also depicts a perspective view of the elements that comprise the flavorings dispenser 104 (the “dispenser”) according to various embodiments of the present invention. In preferred embodiments, FIG. 1 illustrates the neck lock 100 with the push button head lock 102 and the push button arm track 103 attached to the dispenser 104. In this view it is clear that the flat side of the drink passageway 101 of the neck lock 100 are aligned on the flat side of the dispenser 104. Specific elements of the dispenser can be seen in FIG. 1 such as the push button arm track 103 and the flavoring container outer wall 105 as well as the flavoring container divider wall 106. The flavoring container cap 108 is attached to one end of the flavoring container outer wall 105 as well as to the flavoring container divider wall 106 whereby creating a flavoring container 107 with an opening on one side. The flavoring container cap 108, flavoring container wall 105, and the flavoring container divider wall 106 form individual flavoring containers 107. A plurality of flavoring containers make up a flavorings dispenser 104. The taller the dispenser 104 the greater the volume of flavorings each flavoring container 107 can hold. Finally in FIG. 1 a perspective view of a flavorings dispenser 104 being filled with a flavoring 110 by means of a flavoring filling spout 109 into one of a plurality of flavoring containers 107 is depicted. In preferred embodiments of the apparatus all of the flavoring containers will be filled to capacity with drink flavorings 110.

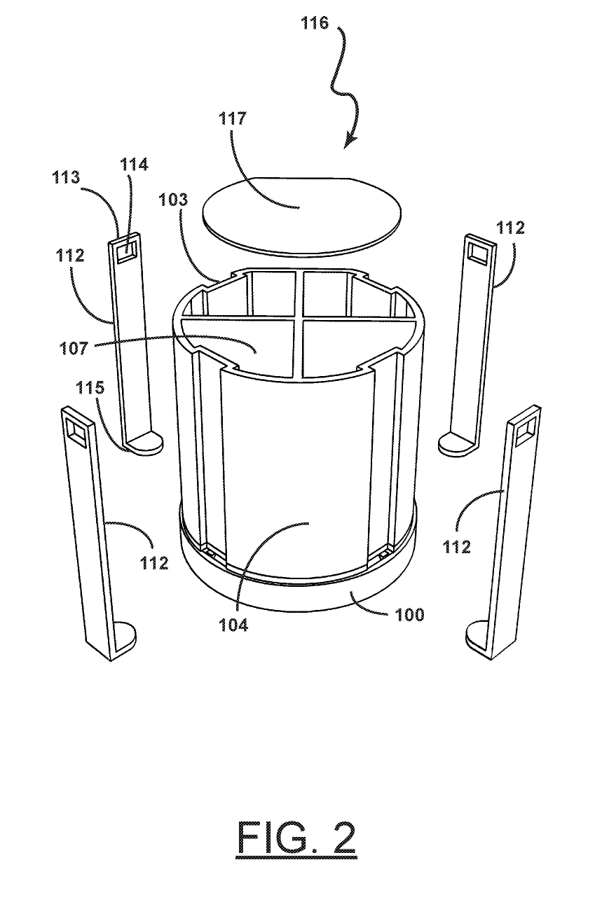

FIG. 2 depicts a perspective view of the elements that comprise a complete selector and dispenser apparatus according to various embodiments of the present invention. In various embodiments, the elements of a push button arm 112 as seen in FIG. 2 include a push button head (button) 115 to be depressed with a finger tip, a flavoring pour hole 114 that allows flavoring to pass through the arm, and finally a seal opening head 113 on one end of the push button arm 112. FIG. 2 depicts an exploded view of the parts that make up a selector and dispenser 116. Clearly depicted here are the push button arms 112 aligned vertically and parallel with the push button arm tracks 103. The flavoring pour hole 114 and seal opening head 113 are aligned on the same side of the dispenser 104 as the openings of the flavoring containers 107 and the flavoring container seal 117. The push button heads 115 are aligned along the neck lock 100 side of the apparatus. The flavoring container seal 117 is a single sheet of plastic or aluminum foil that caps the plurality of flavoring container 107 openings of the dispenser 104 whereby sealing flavorings inside each of the flavoring containers 107 in a leak-free manner. FIG. 2 depicts a perspective view of the parts required for a fully assembled selector and dispenser 116 with the push button arms 112 aligned into position near their respective push button arm tracks 103 of the flavorings dispenser 104. The flavoring container seal 117 is in position to be attached to the flavoring containers of the dispenser 104 as well as to the seal opening head 113 of the push button arm 112 with the flavoring pour hole 114 just below. After the plurality of flavoring containers are full of flavorings they will be sealed in a leak-proof manner by the flavoring container seal 117, whereby preventing the flavorings that fill each of the containers from leaking from the dispenser 104.

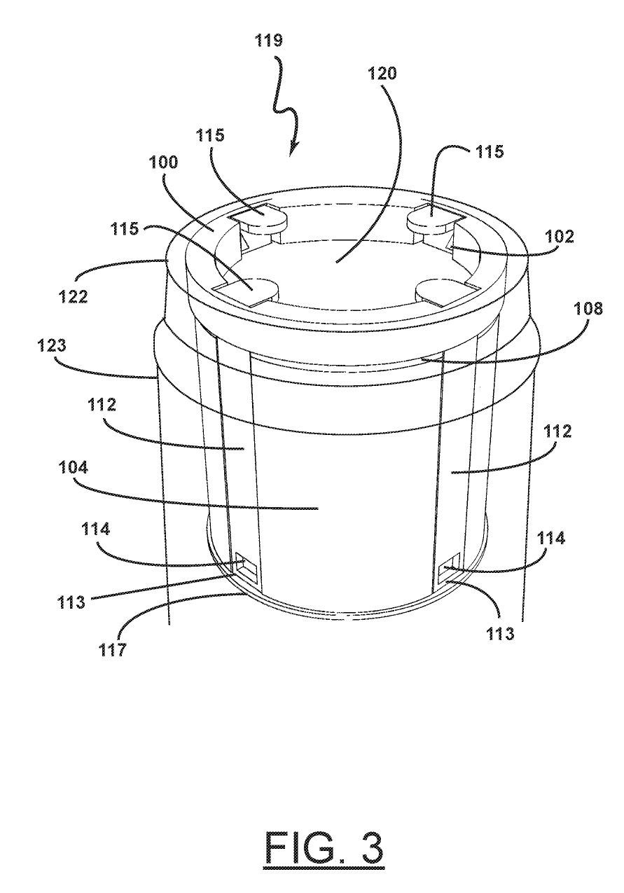

FIG. 3 depicts a perspective view of the complete selector and dispenser in an upright position 119 as well as the apparatus installed inside a drink bottle's neck just below the drink bottle's lip. FIG. 3 illustrates a plurality of push button heads 115 in their proper position at the top of the dispenser 104 along the neck lock 100. The surface at the top center of the apparatus creates a flavoring selection area 120 where graphics can be applied that provide information about the flavorings associated with each of the push button heads 115. The push button arm tracks are clearly visible in this view as well as the push button arms 112 as they run vertically along the dispenser 104. They allow vertical movement of the push button head 115 when depressed. The push button head 115 can move down only as far as the flavoring container cap 108 where it is stopped and held in position by a push button lock 102 preventing the push button head 115 from moving or being retrieved. Also in this view we can see that the flavoring container seal 117 is positioned at the bottom of the apparatus with the seal opening head 113 attached to it and the flavoring pour hole 114 positioned just above. FIG. 3 depicts a complete selector and dispenser 119 installed inside the neck of a drink bottle 123 just below the bottle's lip 122. Illustrated in this view is the neck lock 100 which is suspending the flavoring dispenser 104 in the proper position for use. FIG. 3 depicts the position of the push button heads 115 along the bottle's lip 122 for easy access when in use. Also illustrated here is the flavoring selection area 120 positioned near the top edge of the bottle's lip 122 in a clear line of sight after the drink bottle cap is removed. On the other end of the apparatus depicted in FIG. 3 is the flavoring container seal 117 aligned with the bottom edge of the dispenser 104 and the seal opening head 113 at the bottom of the push button arm 112. Illustrated here as well are the flavoring pour holes 114 positioned just above the seal opening heads.

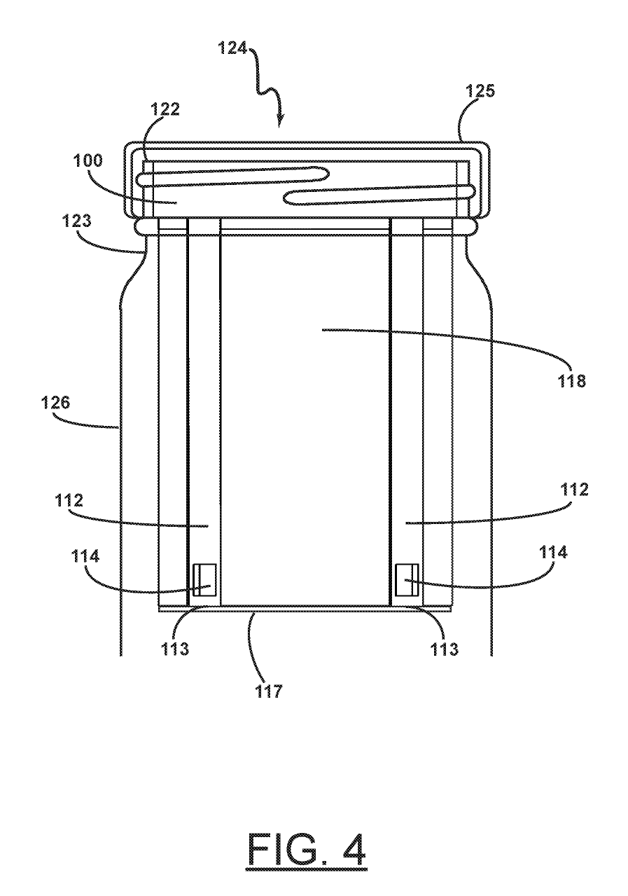

FIG. 4 depicts a side view of the selector and dispenser 124 locked inside a drink bottle's neck 123 just below the drink bottle's lip 122 and inside a drink bottle container 126 with the bottle's cap 125 screwed on tightly according to various embodiments of the present invention. This illustration depicts the selector and dispenser 118 fully contained within a sealed drink bottle both below the bottle's lip 122 and within the drink bottle 126 itself. The drink bottle's cap 125 is screwed on tightly in this side view of the apparatus contained within a drink bottle 124. FIG. 4 depicts the position of the flavoring container seal 117 located at the bottom of the selector and dispenser 118 as well as the flavoring pour holes 114 and the seal opening heads 113 at the ends of the push button arms 112.

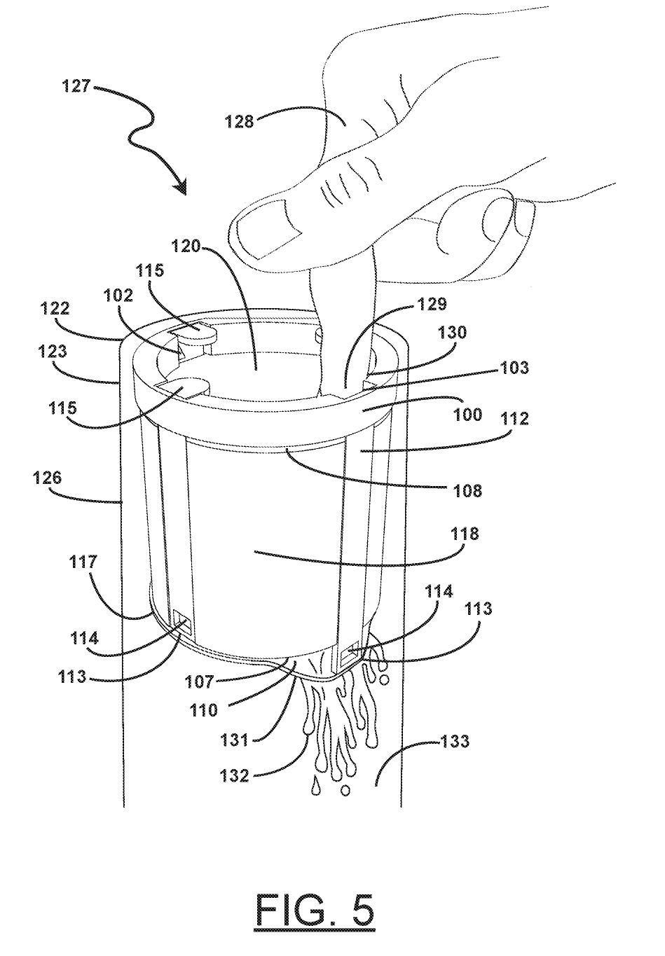

Referring now to FIG. 5, a perspective view of the apparatus in use 127, specifically of the selector and dispenser 118 suspended inside the neck of a drink bottle 123 just below the drink bottle's lip 122, held in position by the neck lock 100, with a flavoring selected from the flavoring selector area 120, a push button head 115 depressed 130 by a finger tip 129 of the user's free hand 128 and flavoring being released 132 into the primary drink 133 contained within the drink bottle 126. More specifically, to use the apparatus it's suggested that a firm grip be made on the drink bottle container 126 after the bottle cap is removed by a free hand 128. Next use one finger of the free hand 129 to depress a push button head 130 until it is stopped by the flavoring container cap 108 and locked in the down position by the push button head lock 102. The push button arm 112 moves vertically along the push button arm track 103 advancing the position of the seal opening head 113 until the flavoring container seal 117 is broken open 131, whereby opening the seal of a single flavoring container 107 without opening other flavoring containers. When the flavoring container seal 117 has been opened 131 by a seal opening head 113 a flavoring is released 132 from a flavoring container 107 and it is also released 132 through a flavoring pour hole 114 of the push button arm 112. The flavoring that has been released 132 mixes with the primary drink 133 located in the drink bottle container 126. The user can add a plurality of available flavorings by depressing 130 additional push button heads 115. After the primary drink 133 has been customized with the added flavoring 110 the bottle cap is then screwed back on the bottle's neck 123 and the drink bottle 128 is shaken in order to mix in the added flavoring(s) 110. The primary drink 133 is now altered with the flavoring(s) 110 released 132 from the apparatus.

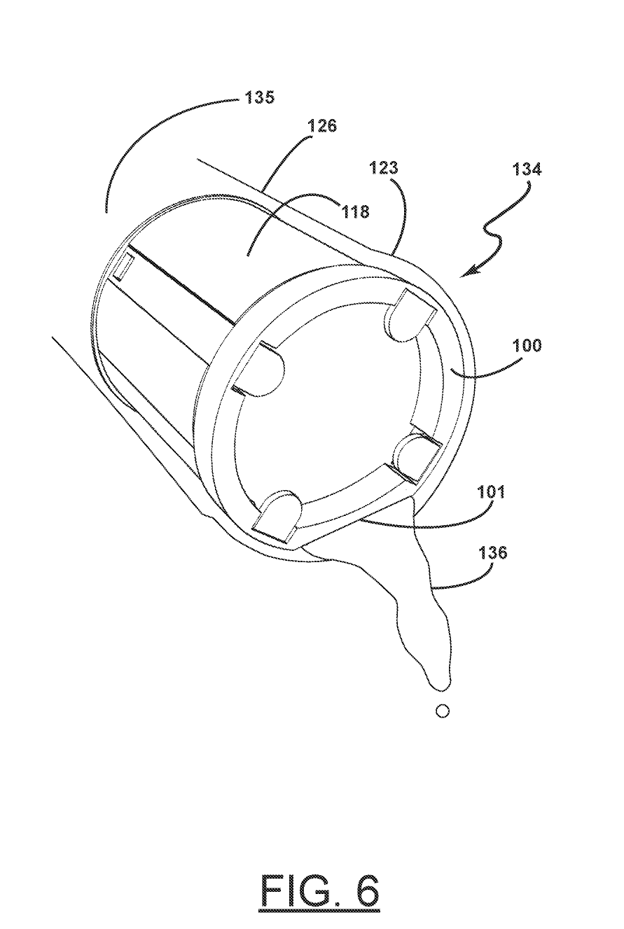

Referring finally to FIG. 6, a perspective view of a complete selector and dispenser 118 locked inside the neck of a drink bottle 123 pouring a drink 136 out of the drink bottle 134. More specifically, FIG. 6 depicts a perspective view of a flavored or unflavored drink 135 pouring 136 through the drink passageway 101 of the neck lock 100 of the apparatus 118. As illustrated here the selector and dispenser 118 remains suspended and locked within the drink bottle 126 before use, during use, while the flavored or unflavored drink 135 is consumed, and after disposal of the drink bottle.

While preferred materials for elements would be food safe plastics, the apparatus is not limited by these materials. Rubber, glass, metal alloys, aluminum and other materials may comprise some or all of the elements of the in-bottle flavoring selector and dispensing apparatus and apparatuses for bottled drinks and beverages in various embodiments of the present invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An in-bottle apparatus for adding flavorings to pre-packaged drinks, comprising:
a drink flavoring container housed completely within a drink bottle below the bottle's lip;
an opening on one end of the drink flavoring container, whereby a flavoring can enter and exit;
a drink flavoring that is added to the drink flavoring container, whereby the drink flavoring container is filled to capacity;
a drink flavoring container that holds a sufficient volume of drink flavoring, such that the drink flavoring will alter the flavor of a primary drink flavor;
a flavoring container seal, such that the drink flavoring within the drink flavoring container is prevented from mixing into the primary drink flavor;
a dispenser configured to hold a plurality of drink flavoring containers inside a drink bottle's neck below a drink bottle's lip;
a neck lock for holding the dispenser in place inside the drink bottle's neck below the drink bottle's lip, such that the dispenser is firmly suspended within the drink bottle and cannot be easily removed;
a push button spacer formed by the height of the neck lock whereby a push button head can be depressed a specific distance;
a push button head located inside the neck of a drink bottle below the bottle's lip, whereby a finger tip can depress the push button head;
a push button head lock configured to hold down the push button head after a finger tip has depressed it, such that the button head remains immobile and cannot be retrieved;
a flavoring selection area displaying the drink flavoring(s) that will be released from the dispenser into the primary drink after a finger tip has depressed the push button head, whereby a user can know the particular flavoring associated with each push button head;
a push button arm connected to the push button head, such that the arm extends to the bottom of the dispenser that is locked inside a drink bottle;
a seal opening head attached to the end of the push button arm, such that when the push button head is depressed the push button arm moves the seal opening head vertically whereby breaking open the flavoring container seal and releasing a flavoring from the flavoring container into the primary drink contained within the drink bottle;
a flavoring pour hole next to the seal opening head on the push button arm, such that after the flavoring container seal has been pushed open by the seal opening head the flavoring can pour through the hole in the push button arm into the primary drink;
a push button arm track configured inside the neck lock and along the outside of the dispenser allowing the push button arm to slide vertically inside the drink bottle and maintain alignment;
a push button arm inserted into the push button arm track, such that vertical motion is made possible; and
an opening on one side of the apparatus forming a fluid passage way, whereby the drink can be poured out of the drink bottle and consumed;

2. An apparatus as defined in claim 1, further comprising a neck lock located at the very top of the apparatus.

3. An apparatus as defined in claim 2, further comprising a neck lock that is too wide to pass through the drink bottle's neck and at the same time conforms to the drink bottle's lip diameter so that the apparatus remains immobile even when the drink bottle is vigorously shaken.

4. An apparatus as defined in claim 3, further comprising a neck lock attached to a drink bottle with adhesives so that the apparatus cannot be retrieved or removed from the drink bottle.

5. An apparatus as defined in claim 1, further comprising a push button head that is clearly displayed along the lip of a drink bottle after the bottle cap is removed.

6. An apparatus as defined in claim 5, further comprising a push button arm, attached to the push button head, that extends vertically to the bottom of the dispenser along the push button arm track.

7. An apparatus as defined in claim 6, further comprising a seal opening head at the end of a push button arm, such that the seal opening head is attached to one side of a flavoring container seal.

8. An apparatus as defined in claim 7, wherein a seal opening head is adhered to a flavoring container seal, such that the seal opening head is able to break open the flavoring container seal from the flavoring container when the push button arm moves vertically.

9. An apparatus as defined in claim 8, further comprising a push button head that is depressed the vertical distance necessary to break open a flavoring container seal.

10. An apparatus as defined in claim 1, further comprising a push button arm with a flavoring pour hole, whereby flavoring can pour through the push button arm out of the flavoring container.

11. An apparatus as defined in claim 1, further comprising push button arm tracks that are tightly fitted to the push button arms allowing very little horizontal movement.

12. An apparatus as defined in claim 1, further comprising a flavoring container that stores a volume of flavoring sufficiently large enough to alter the taste of a bottled drink.

13. An apparatus as defined in claim 1, further comprising a single container seal that caps a plurality of flavoring containers simultaneously, whereby preventing flavorings from being released.

14. An apparatus as defined in claim 13, further comprising a single container seal that can be partially opened releasing flavoring from only one flavoring container without releasing flavoring from other flavoring containers.

15. An apparatus as defined in claim 1, further comprising an individual seal for each flavoring container, whereby each flavoring container is independently sealed rather than sharing a seal.

16. An apparatus as defined in claim 1, further comprising a flavoring selector and dispenser apparatus that is fully contained within a sealed pre-packaged drink bottle.

17. An apparatus as defined in claim 16, further comprising a pre-packaged drink that can have its flavor customized by flavorings that are fully contained within a pre-packaged sealed drink bottle.

18. An apparatus as defined in claim 17, further comprising a pre-packaged drink that allows a user to mix and match flavorings that are contained within the drink bottle such that the user has the ability to select multiple flavoring combinations.

19. A method for adding in-bottle flavorings to pre-packaged drinks, comprising:
opening a bottle cap of a pre-packaged drink bottle with a flavoring selector and dispenser apparatus fully contained inside the drink bottle;
visually focus on a flavoring selector area of the selector and dispenser apparatus installed just below the lip of the opened drink bottle and choose a flavoring to be added to a drink stored within the drink bottle;
using a finger tip on a free hand to depress a push button head associated with the flavoring that is to be added to the primary drink;
depressing the push button head until it clicks and is locked down against a flavoring container cap;
waiting a period of time whereby a flavoring is released from a flavoring dispenser into the primary drink flavor contained within the drink bottle;
resealing the drink bottle with the bottle cap, and shaking the bottle vigorously while gripping tightly on the drink bottle with one or both hands such that the released flavoring mixes into the primary drink flavor; and
opening the bottle cap again and pouring the flavored drink through the drink passageway on one side of the selector and dispenser apparatus locked and suspended within the drink bottle just below the bottle's lip;

20. A method as defined in claim 19, whereby depressing a plurality of push button heads rather than just one push button head, such that the flavor of the primary drink is augmenting with multiple flavorings rather than just one flavoring.
